(19) United States
(12) Patent Application Publication
(10) Pub. No.: US 2017/0110220 A1
(43) Pub. Date: Apr. 20, 2017

(54) Synthetic Power Cable For Downhole Electrical Devices

(71) Applicants: MICHAEL C. ROMER, THE WOODLANDS, TX (US); RANDY C. TOLMAN, SPRING, TX (US)

(72) Inventors: MICHAEL C. ROMER, THE WOODLANDS, TX (US); RANDY C. TOLMAN, SPRING, TX (US)

(21) Appl. No.: 15/218,552

(22) Filed: Jul. 25, 2016

Related U.S. Application Data
(60) Provisional application No. 62/241,395, filed on Oct. 14, 2015.

(51) Int. Cl. H01B 9/00; E21B 17/00; E21B 43/12

(52) U.S. Cl. CPC H01B 9/006; E21B 43/128; E21B 17/003; F04B 17/03

(57) ABSTRACT

A power cable bundle is provided herein. The power cable bundle includes a spool having an axle, and a power cable wound there around. The power cable comprises a plurality of conductor wires, and a non-conductive, high-strength, synthetic material around the plurality of conductor wires substantially along its length. The power cable has a tensile strength of at least 2,000 MPa, and a weight that is less than 0.1 lb./ft. in air. Preferably, the power cable is at least 2,000 feet in length. A method of pumping fluids from a wellbore using an electrical submersible pump that receives electrical power through the power cable is also provided herein.

### CROSS REFERENCE TO RELATED APPLICATIONS

This application claims the benefit of U.S. Provisional Patent Application No. 62/241,395 filed Oct. 14, 2015, entitled “Synthetic Power Cable for Downhole Electrical Devices,” the entirety of which is incorporated by reference herein.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Field of the Invention

The present disclosure relates to the field of well completions. More specifically, the present invention relates to the delivery of power to an electrical device within a wellbore, such as a submersible pump, using a significantly strengthened power cable.

Discussion of Technology

In the drilling of an oil and gas well, a wellbore is formed through the earth using a drill bit urged downwardly at a lower end of a drill string. After drilling to a predetermined bottomhole location, the drill string and bit are removed and the wellbore is lined with a string of casing. An annular area is thus formed between the string of casing and the formation penetrated by the wellbore.

In a vertical wellbore, or in the vertical section of a horizontal well, a cementing operation is typically conducted in order to fill or “squeeze” the annular volume with cement along the length of the wellbore. The combination of cement and casing strengthens the wellbore and facilitates the zonal isolation, and subsequent completion, of hydrocarbon-producing pay zones behind the casing.

It is common to place several strings of casing having progressively smaller outer diameters into the wellbore. The process of drilling and then cementing progressively smaller strings of casing is repeated several times until the well has reached total depth. The final string of casing is referred to as a production casing. In some instances, the final string of casing is a liner, that is, a string of casing that is not tied back to the surface.

As part of the completion process, the production casing is perforated at one or more desired levels. Alternatively, a sand screen may be employed in the event of an open hole completion. Either option provides fluid communication between the wellbore and a selected zone in a formation. In addition, production equipment such as tubing, packers and pumps may be installed within the wellbore. A wellhead is installed at the surface along with fluid gathering and processing equipment. Production operations may then commence.

FIG. 1 presents a side, cross-sectional view of an illustrative well site 100. The well site 100 includes a wellbore 150 extending from the earth surface 101 and down into an earth subsurface 155. The wellbore 100 has been formed for the purpose of producing hydrocarbon fluids from a subsurface formation 175 for processing or for commercial sale.

The wellbore 150 has been completed with a series of pipe strings, referred to as casing. First, a string of surface casing 110 has been cemented into the formation. Cement is shown in an annular bore 115 of the wellbore 150 around the casing 110. The cement is in the form of an annular sheath 112. The surface casing 110 has an upper end in sealed connection with a lower valve 164 at the surface 101.

Next, at least one intermediate string of casing 120 is cemented into the wellbore 150. The intermediate string of casing 120 is in sealed fluid communication with an upper valve 162 at the surface 101. A cement sheath 112 is again shown in the bore 115 of the wellbore 150. The combination of the casing 110/120 and the cement sheath 112 in the bore 115 strengthens the wellbore 150 and facilitates the isolation of formations behind the casing 110/120.

It is understood that a wellbore 150 may, and typically will, include more than one string of intermediate casing. In some instances, an intermediate string of casing may be a liner. It is also understood that the upper valve 162 and the lower valve 164 are part of a well head 160, which is somewhat schematically shown. The wellhead 160 will include various valves (such as valve 167) for controlling the flow of fluids into and out of the wellbore 150.

In addition, a production string 130 is provided. The production string 130 is hung from the intermediate casing string 120 using a liner hanger 131. The production string 130 is a liner that is not tied back to the surface 101. In the arrangement of FIG. 1, a cement sheath 132 is provided around the liner 130.

The production string 130 extends into a subsurface formation 175. The production string 130 has a lower end 134 that traverses to an end 154 of the wellbore 150. For this reason, the wellbore 150 is said to be completed as a cased-hole well.

The production string 130 has been perforated after cementing. Two illustrative perforations are shown at 149, although it is understood that numerous additional perforations will likely be formed. The perforations 149 create fluid communication between a bore 135 of the liner 130 and the surrounding rock matrix making up the subsurface formation 175. The formation 175 has been fractured through the perforations 149. Fractures 159 are shown in FIG. 1 extending from perforations 149.

The wellbore 150 finally includes a string of production tubing 140. The production tubing 140 extends from the wellhead 160 down to the subsurface formation 155. The production tubing 140 forms a bore 145 that carries production fluids from the subsurface formation 175 to the wellhead 160. In the arrangement of FIG. 1, the production tubing 140 terminates above the perforations 159. However, it is understood that the production tubing 140 may terminate anywhere along the subsurface formation 175.

A production packer 141 is provided along the production tubing 140. The illustrative packer 141 is placed proximate the top of the subsurface formation 175. In this way, the packer 141 is able to seal off the annular region 136 between the tubing 140 and the surrounding production liner 130. Production fluids are thus forced up the bore 145.

The wellbore 150 optionally includes one or more gas lift valves 144. The gas lift valves 144 reside along the production tubing 140 above the packer 141. The gas lift valves 144 receive gas injected into the annulus 136 between the production tubing 140 and the surrounding casing 130. The gas lift valves 144 then inject that gas into the bore 145 of the production tubing 140 for the purpose of reducing the density of the wellbore fluids.

In order to inject the gas, a gas injection line 166 is provided along the wellhead 160. The wellhead 160 includes a gauge 165 and a pressure regulator 168. Typically, the gas that is injected is separated gas that has been produced from the subsurface formation 155, or it may be a storage of gas held in a pressurized tank. A gas compressor (not shown) that is located at the surface 101 or in the field pressurizes gas that is communicated to the annulus 136 of the wellbore 150. A valve, such as motor valve 163, controls the injection of gases into the annular region 136.

The well tree 160 includes a shut-in valve 167 that controls the flow of production fluids from the wellbore 100. In addition, a subsurface safety valve 125 is provided to block the flow of fluids from the production tubing 140 in the event of a rupture or catastrophic event above the subsurface safety valve 125. Fluid gathering and processing equipment (not shown in FIG. 1) such as pipes, valves, separators, dehydrators, gas sweetening units, and oil and water stock tanks may also be provided.

It is understood that the well site 100 is merely illustrative of one arrangement for a wellbore completion. Those of ordinary skill in the art will readily understand that the majority of modern completions include an extended horizontal section that may itself be over 5,000 feet in length. Such wellbores will typically still have either a string of production casing 130, or a series of sand screens (not shown) placed along an open hole bore. The sand screens will frequently employ transport conduits and gravel packing conduits (or “shunt tubes,” not shown) that permit gravel slurry to be delivered across the length of the pay zone, bypassing any sand bridges and even packers.

In many well completions, the subsurface pay zones (such as formation 175) are incapable of flowing fluids to the surface efficiently. This may be because the reservoir pressure is insufficient to overcome the hydrostatic head in the production tubing 140. This is particularly true in deeper wells or in wells that have been producing for a period of time and have experienced a loss of formation pressure. When this occurs, the operator may include artificial lift equipment as part of the wellbore completion. Artificial lift equipment may include a downhole pump connected to a surface pumping unit via a string of sucker rods run within the tubing. Alternatively, an electrically-driven submersible pump may be placed at the bottom end of the production tubing 140. In addition, gas lift valves 144 may be installed along the production tubing 140 to assist fluid flow to the surface 101.

State of the art electrical submersible pumps comprise a cylindrical assembly which resides at the base of the production string. The pump includes a rotary electric motor which turns turbines at a high horsepower. These turbines are placed below the producing zone of a well and act as fans for forcing production fluids upward through the production tubing 130. The pump is powered by a cable extending from the surface 101 to the bottom of the production tubing 140, and residing in an annular space 136 between the tubing 130 and the surrounding production casing 130.

It is alternatively known to employ a linear electric motor for downhole pumping. These pumps include a linear motor having a series of windings which act upon an armature. The power supply generates a magnetic field within the coils which, in turn, imparts an oscillating force upon the armature. In the case of a linear electric motor, the armature would be translated in an up-and-down fashion within the well. The armature, in turn, imparts translational movement to a piston, or connector shaft, residing below the motor. The linear electric motor thus enables the piston of a positive displacement pump to reciprocate vertically, thereby enabling fluids to be lifted with each stroke of the piston.

Currently, small electrical pumps known as “micro-PD pumps” are being considered for downhole operations. Micro-PD pumps rely upon positive displacement technology, but in a design that is much smaller than the single stroke, positive displacement ESP's commonly used in wellbores. In a micro-PD pump, pump rate is controlled through an on-board programmable logic controller that sets the stroke frequency. The motor may be either AC or DC.

In addition, solid state pumps are currently being developed for installation into wellbores. Solid state pumps are electrical submersible pumps that employ a solid state fluid sensor called field-effect.

In any instance, electrical power must be delivered to the downhole pumping device. This is done by delivering power from the surface 101 down a power cable (not shown in FIG. 1) that is run along the tubing string 140. The power cable is connected to a submersible electric motor by a connector, sometimes referred to as a pothead. The submersible motor is generally a three-phase motor, and the pothead is designed as a single connector having a triad configuration of three conductors for carrying three-phase power.

Downhole power cables are frequently 7/16″ wireline cables capable of transmitting about 2,500 Watts of electricity. The cables may, for example, have seven conductor wires for servicing the electrical load. A typical wireline has a break strength of about 20,000 lb. To support this load, the typical wireline is fabricated from carbon steel, and has a weight of about 0.365 lb./ft. in the air. This means that a 10,000 foot spool would weigh 3,650 pounds. Although this is manageable, a lighter cable would be easier to handle, and longer cable lengths could be wound on the same size spool without additional concerns for crushing the innermost layer or the spool. In addition, a lighter cable would also reduce the tensile strength requirement for pulling the cable back out of the wellbore.

Accordingly, a need exists for a power cable suitable for delivering electrical power (or electro-magnetic energy) to a submersible pump in a wellbore, that has a lighter weight without compromising tensile strength. In addition, a need exists for a power cable fabricated from a material that is not susceptible to the corrosive effects of H₂S, CO₂ or other corrosive wellbore fluids, as is the case with carbon steel. Still further, a need exists for a power cable that has a longer wellbore life without need of corrosion inhibitors being injected periodically into the wellbore.

### SUMMARY OF THE INVENTION

A load-bearing power cable is first provided herein. The power cable is designed to reside and operate within a wellbore. Preferably, the wellbore has been completed vertically, although any inclination is appropriate. More preferably, the wellbore is an extended length wellbore that traverses more than 8,000 feet of hole. Preferably, the individual conductors comprise stranded wires.

The power cable first comprises a plurality of internal conductor wires, such as copper wires. The conductor wires together are capable of carrying current sufficient to generate at least 1,500 Watts of electricity. The conductor wires are configured to provide power to a downhole electrical device, such as a submersible pump.

Each conductor wire is insulated by a light-weight, non-conductive, synthetic material having a high tensile strength. The synthetic material is fabricated at least partially from high modulus polyethylene filaments, lyotropic polymer filaments, thermotropic polymer filaments, or combinations thereof. Non-limiting examples of suitable non-conductive, non-corrosive, light-weight materials include Kevlar®, Twaron®, Zylon®, Dyneema®, Vectran®, Spectra®, Technora® and combinations of fibers thereof.

The synthetic insulating material runs substantially along the length of each conductive wire. The insulating material is capable of gravitationally supporting the downhole electrical device. The insulating material gives the power cable a tensile strength of at least 2,000 MPa (or at least 29,075 psi) during load bearing. Because of its materials, the power cable is light-weight, having a weight that is less than 0.1 lb./ft. in air.

In one aspect, the insulated conductors are aligned axially along the length of the cable, and then bundled within a thin outer sheath such as a polypropylene jacket. The outer sheath does not have a significant load-bearing function. Preferably, the conductor wires are individually held within separate inner sheaths, and a filler material is then placed around the conductor wires within the outer sheath. The inner sheaths are fabricated from a non-conductive, synthetic, load-bearing material having a high tensile strength. In one aspect, the filler material also comprises a synthetic, high tensile-strength material.

In another embodiment, the insulated conductors are aligned co-axially along the length of the cable. In still another embodiment, single or multiple insulated conductors are braided or twisted, and then placed within separate non-conductive inner sheaths. In this embodiment, the inner sheaths may be polymeric jackets having no significant load-bearing function. The conductor wires are then again bundled within a non-conductive outer sheath. A non-conductive, polymeric, load-bearing material fills the annular space between the conductor wires and the surrounding outer sheath to provide the tensile strength.

In either embodiment, fiber optic cables, hydraulic lines, chemical injection lines, or other service lines may be added within the non-conductive and corrosion-resistant outer sheath. Optionally, additional layers of polymer or other cladding material may be added to the outer sheath for insulation, durability, gas migration prevention, or other needs.

A cable bundle is also provided herein. The cable bundle contains at least 5,000 feet of cable, with the cable itself being fabricated in accordance with the various embodiments described above. The cable is wound about a spool for ease of storage, portability and dispensing. The spool includes a central axle that may be turned either by mechanical means or by means of an electric motor.

A method for pumping wellbore fluids from a subsurface formation is also provided herein. The method first comprises providing an electrical submersible pump in a wellbore. The electrical submersible pump may have a rotary motor or a linear drive motor. In one aspect, the electrical pump is a micro-positive displacement pump, or a pair of micro-positive displacement pumps placed downhole. In another embodiment, the electrical pump is a solid state pump.

The method also includes providing a synthetic power cable. The power cable has a plurality of conductor wires for conveying electrical power. The power cable is constructed in accordance with any of the embodiments presented herein.

The method further includes connecting a distal end of the electrical cable to the electrical submersible pump. Preferably, this is done before the pump is run into the wellbore.

The method also includes unspooling the electrical cable and connected submersible pump into the wellbore. In one aspect, the electrical cable is connected to an outer diameter of a production tubing, and the cable is unspooled as the production tubing is run into the wellbore, joint by joint. More preferably, the electrical cable and connected submersible pump are lowered into the production tubing.

The method additionally includes connecting a proximal end of the power cable to a power source at the surface. The method then includes sending electrical power through the conductor wires within the power cable, and down to the electrical submersible pump.

The method finally includes operating the electrical submersible pump to pump fluids up the production tubing and to the surface. The fluids are preferably hydrocarbon liquids.

### BRIEF DESCRIPTION OF THE DRAWINGS

So that the manner in which the present inventions can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1 is a side, cross-sectional view of a wellbore. The illustrative wellbore has been drilled vertically into a subsurface formation. The formation is under formation pressure and contains hydrocarbon fluids.

FIG. 2 is a perspective view of a synthetic power cable of the present invention. The illustrative power cable is part of a spool, forming a cable bundle.

FIG. 3A is an enlarged, axial cross-sectional view of the power cable of FIG. 2, in one embodiment. Seven conductor wires are shown. The conductor wires are insulated using a high-strength synthetic material, and have a surrounding filler material.

FIG. 3B-1 is an enlarged, axial cross-sectional view of the power cable of FIG. 2, in an alternate embodiment. Here, seven conductor wires are again shown. The conductor wires are insulated using a thin inner sheath, and have a surrounding high-strength, synthetic filler material.

FIG. 3B-2 is a further enlarged, perspective, cut-away view of the power cable of FIG. 3B-1, in one embodiment. Here, the seven conductor wires are shown in stranded form. The conductor wires are again insulated using a thin inner sheath, and have a surrounding high-strength, synthetic filler material.

FIG. 3C is an enlarged, axial cross-sectional view of the power cable of FIG. 2, in yet another alternate embodiment. Here, five illustrative conductor wires are shown, along with a fiber optic data cable and two service lines.

FIG. 4 is a longitudinal, cut-away view of the cable of FIG. 2. Here, the cable is schematically shown mechanically connected to a downhole electrical device.

FIG. 5 presents a flowchart for a method of pumping fluids from a wellbore, in one embodiment. The method involves running a synthetic, high tensile-strength, power cable and connected submersible pump into a wellbore, and then actuating the pump to move hydrocarbon fluids from a subsurface formation to the surface.

### DETAILED DESCRIPTION OF CERTAIN EMBODIMENTS

### Definitions

As used herein, the term “hydrocarbon” refers to an organic compound that includes primarily, if not exclusively, the elements hydrogen and carbon. Hydrocarbons generally fall into two classes: aliphatic, or straight chain hydrocarbons, and cyclic, or closed ring hydrocarbons, including cyclic terpenes. Examples of hydrocarbon-containing materials include any form of natural gas, oil, coal, and bitumen that can be used as a fuel or upgraded into a fuel.

As used herein, the term “hydrocarbon fluids” refers to a hydrocarbon or mixtures of hydrocarbons that are gases or liquids. For example, hydrocarbon fluids may include a hydrocarbon or mixtures of hydrocarbons that are gases or liquids at formation conditions, at processing conditions or at ambient conditions (15° C. to 20° C. and 1 atm pressure). Hydrocarbon fluids may include, for example, oil, natural gas, coal bed methane, shale oil, pyrolysis oil, pyrolysis gas, a pyrolysis product of coal, and other hydrocarbons that are in a gaseous or liquid state.

As used herein, the term “fluid” refers to gases, liquids, and combinations of gases and liquids, as well as to combinations of gases and solids, and combinations of liquids and solids.

As used herein, the term “production fluids” refers to those fluids, including hydrocarbon fluids, which may be received from a subsurface formation into a wellbore.

As used herein, the term “subsurface” refers to geologic strata occurring below the earth's surface.

The term “subsurface interval” refers to a formation or a portion of a formation wherein formation fluids may reside. The fluids may be, for example, hydrocarbon liquids, hydrocarbon gases, aqueous fluids, or combinations thereof. The terms “zone” or “zone of interest” may be used to refer to a portion of a subsurface interval.

As used herein, the term “wellbore” refers to a hole in the subsurface made by drilling or insertion of a conduit into the subsurface. A wellbore may have a substantially circular cross section, or other cross-sectional shape. As used herein, the term “well,” when referring to an opening in the formation, may be used interchangeably with the term “wellbore.”

### Description of Specific Embodiments

The inventions are described herein in connection with certain specific embodiments. However, to the extent that the following detailed description is specific to a particular embodiment or a particular use, such is intended to be illustrative only and is not to be construed as limiting the scope of the inventions.

Certain aspects of the inventions are also described in connection with various figures. In certain of the figures, the top of the drawing page is intended to be toward the surface, and the bottom of the drawing page toward the well bottom. While wells commonly are completed in substantially vertical orientation, it is understood that wells may also be inclined and or even horizontally completed. When the descriptive terms “up and down” or “upper” and “lower” or similar terms are used in reference to a drawing or in the claims, they are intended to indicate relative location on the drawing page or with respect to claim terms, and not necessarily orientation in the ground, as the present inventions have utility no matter how the wellbore is orientated.

The present disclosure presents a novel power cable fabricated from a material comprising a light-weight, high-strength synthetic substance. The power cable is designed to reside and operate within a wellbore. Preferably, the wellbore 100 has been completed vertically, although any inclination is appropriate. More preferably, the wellbore 100 is an extended length wellbore of more than 8,000 feet of hole. The synthetic material is resistant to the high temperature, high pressure and corrosive environments found in many wellbores.

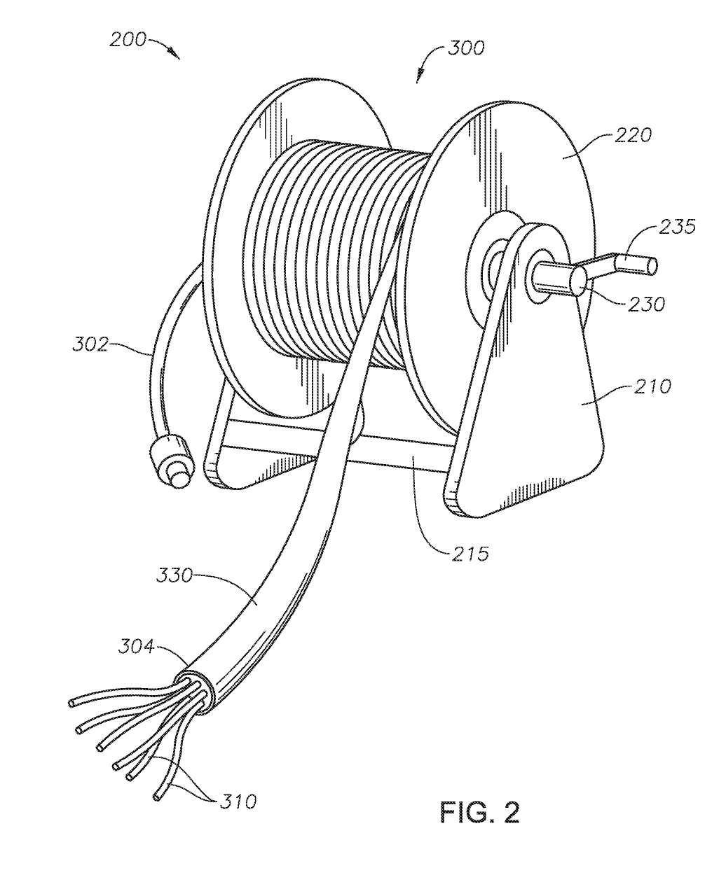

FIG. 2 is a perspective view of a power cable 300 of the present invention. The illustrative power cable 300 is shown as part of a spool 200. The spool 200 is preferably capable of holding and supporting at least 5,000 feet and, more preferably 7,500 feet of cable 300. Together, the spool 200 and cable 300 form a cable bundle.

The illustrative spool 200 has a pair of opposing support legs 210. The legs 210 are connected through one or more intermediate support beams 215. An axle 230 runs between the support legs 210 in transverse relation. The axle 230 is rotationally attached to a pair of opposing fly wheels 220. The fly wheels 220 help contain the cable 300 as it is wound around and unwound from the axle 230.

In the illustrative spool 200, the axle 230 is turned manually by means of a handle 235. However, it is understood that for large, industrial length power cables, the spool 200 may be turned through an electrically driven motor (not shown). In one option, the spool 200 does not have supporting legs 210, but is mounted to a mechanized rotational drive assembly at the well site 100 for unspooling the cable 300 into the wellbore 150.

In FIG. 2, a first (or proximal) end of the cable 300 is seen at 302. The proximal end 302 is configured to plug into a power source. The connection may be, for example, at a junction box (not shown) adjacent to a well site 100. Alternatively, the connection may be at an on-site power generator or a nearby power line. The present inventions are not limited by the configuration of the proximal end 302 or how the cable 300 is connected to a power source.

FIG. 2 also shows a distal end 304 of the cable 300. The distal end 304 reveals that the cable 300 comprises a plurality of conductor wires 310 that are optionally encapsulated by a non-conductive outer sheath 330. An example of a suitable outer sheath 330 is a polypropylene jacket.

In one embodiment, the insulated conductors 310 are axially aligned. In another embodiment, the conductor wires 310 are aligned co-axially. In still another embodiment, single or multiple insulated conductors 310 are braided or stranded, and then optionally bundled within the non-conductive outer sheath 330. The outer sheath 330 is preferably extruded as a smooth, uniform O.D. for the cable 300.

In any arrangement, the cable 300 represents a light-weight, synthetic, load bearing power cable. The power cable 300 is designed to reside and operate within a wellbore such as wellbore 150, and to deliver power to a downhole electrical device such as an electrical submersible pump (seen schematically in FIG. 4 at 400). The power cable 300 is capable of transmitting current sufficient to generate at least 1,500 Watts of electricity, and more preferably, at least 2,500 Watts of electricity. In one aspect, the power cable 200 weighs less than 0.1 lb./ft. in air.

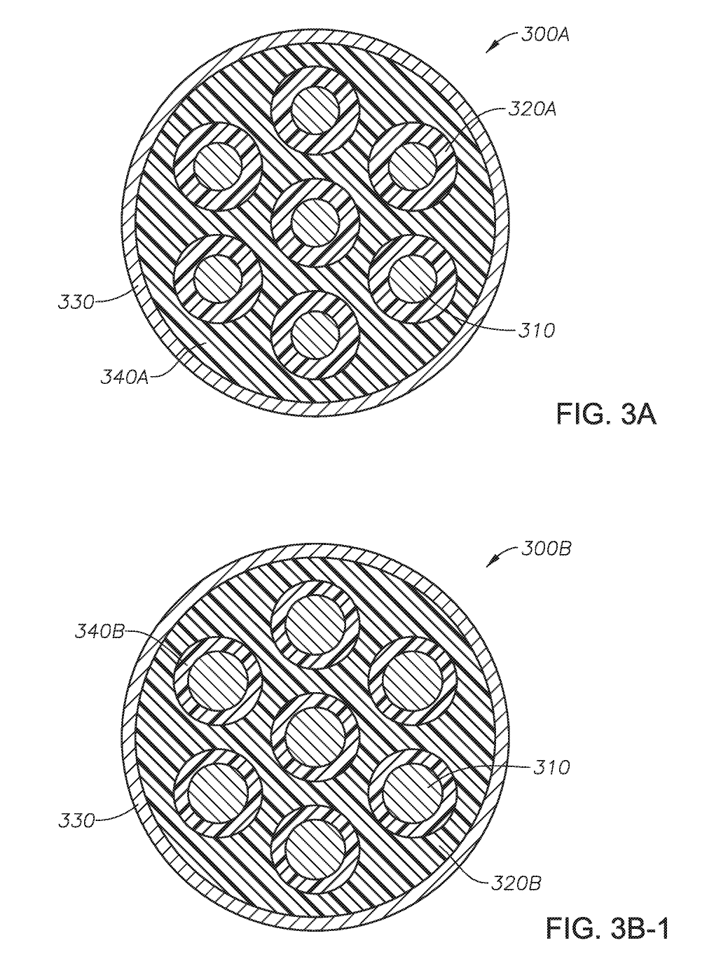

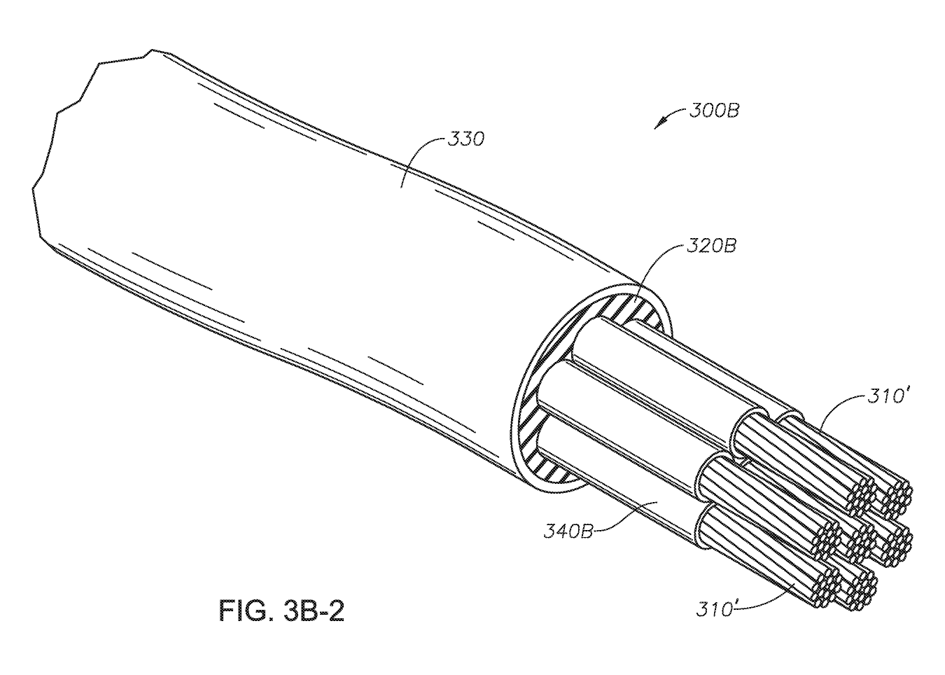

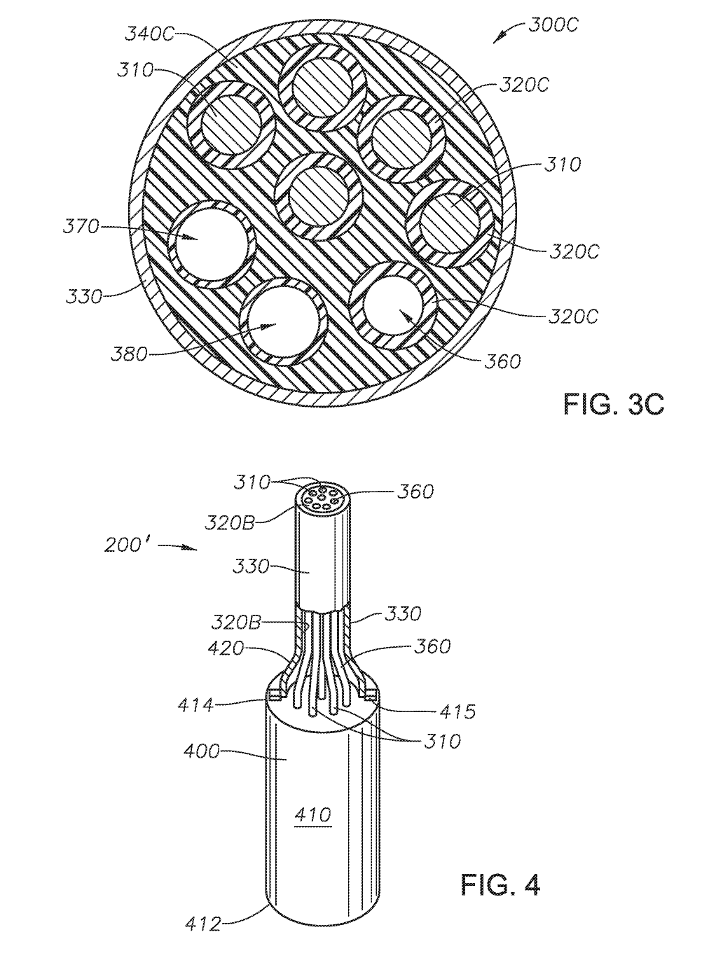

FIG. 3A is an enlarged, axial cross-sectional view of power cable 300A, representative of the power cable 300 of FIG. 2, in one embodiment. From FIG. 3A, it can be seen that the power cable 300A first comprises a plurality of internal conductor wires 310. In the arrangement of FIG. 3A, seven separate conductor wires 310 are provided, although pump wattage requirements may require more or fewer conductor wires 310. The conductor wires 310 are preferably fabricated from copper and preferably stranded for flexibility. Thus, while conductor wires 310 are shown illustratively as solid wires, those of ordinary skill in the art will understand that the conductors 310 are preferably multiple strand bundles.

It is observed here that the conductor wires 310 will have a designated gauge. American wire gauge (AWG), is a standardized wire gauge system used since 1857 in North America for the diameters of round, solid, non-ferrous, electrically conducting wire. Dimensions of the wires are given in ASTM standard B 258. Increasing gauge numbers denote decreasing solid wire diameters. The cross-sectional area of each gauge is an important factor for determining its current-carrying capacity.

AWG tables exist which list single, solid, round conductors. The AWG of a stranded wire is determined by the cross-sectional area of the equivalent solid conductor. Because there are necessarily small gaps between the strands, a stranded wire will always have a slightly larger overall diameter than a solid wire with the same AWG. At the same time, the stranded wire will be more flexible to bends and twists.

Stranded wire varies in flexibility based on the number of strands and the strand size (diameter). The most flexible wire of a given overall AWG will have the most strands and the smallest strands. These are arranged so that several wires (commonly 6 or 18) surround a single wire at the bundle's center. The outer wires are typically wrapped helically around the central wire through a process called helical stranding. Helical stranding of the wires around the center wire causes all the individual elements of the stranded conductor to pull toward its center when the cable is bent, keeping the configuration of all the elements constant. Their paths around the central conducting wire ensure that the stresses on individual wires are averaged over the length, and that the total stresses are distributed over all the strands to minimize the stresses on the center conductor.

Conductor wires in stranded cables are usually made of bare or tin-coated copper wires. Tin-coated conductors are made by dipping the individual wire strands in a bath of molten tin before their assembly into a single conductor. In addition to protecting the conducting surfaces of the individual strands from oxidation, the tin coating makes the fine wire strands easier to solder onto and reduces the fraying of individual wire strands.

Returning to FIG. 3A, each conductor wire 310 is insulated by a non-conductive and non-corrosive synthetic material. In the arrangement of FIG. 3A, the synthetic material defines a jacket around each conductor wire 310 to form an inner sheath 320A. Each inner sheath 320A preferably has a thickness no greater than 1,500 μm or, more preferably, 1,000 μm. In this embodiment, the synthetic material making up each inner sheath 320A has a tensile strength of at least 2,000 MPa (or about 29,075 psi), and preferably greater than 3,000 MPa (or 43,500 psi) to provide a high load bearing function. In addition, the synthetic material making up each inner sheath 320A has a relative density of at least 1.00.

The synthetic material that makes up the inner sheaths 320A is fabricated at least partially from high modulus polyethylene filaments, lyotropic polymer filaments, thermotropic polymer filaments, or combinations thereof. Non-limiting examples of suitable non-conductive, non-corrosive materials include Kevlar®, Twaron®, Zylon®, Dyneema®, Vectran®, Spectra®, Technora®, or combinations of fibers thereof.

Kevlar® is the brand name for a para-polyaramid synthetic fiber. The full chemical name for Kevlar® is poly-praraphenylene terephthalamide. The Kevlar® brand name is owned by E. I. du Pont de Nemours and Co. of Wilmington, Del. Kevlar® is available in the form of thin fibers forming aramid yarn.

Twaron® is the brand name for a p-phenylene terephthalamide (PpPTA), which is the simplest form of the AABB para-polyaramid fiber. The Twaron® brand name is owned by Teijin Aramid B.V. Limited Liability Company of Arnhem, The Netherlands.

Kevlar® and Twaron® have roughly the same chemical structure, and are best known for their uses as body armor material, such as “bullet proof” protective vests, ballistic shields and combat helmets. Kevlar® and Twaron® are valued for their high tensile-strength-to-weight ratios, making them up to five times stronger than steel. When used as a woven material, Kevlar® and Twaron® are suitable for use as high-strength mooring lines.

Technora® is the brand name for another para-polyaramid synthetic fiber. The Technora® brand name is owned by Teijin Techno Products Limited Corporation of Osaka, Japan. The Technora® polymer is closely related to Teijin's Twaron® and DuPont's Kevlar®. Technora® is principally known for its use as a high-strength rope material.

Vectran® is a liquid crystal polymer that is extruded as a fibrous material. Vectran® fibers are used as reinforcing (matrix) fibers for ropes, cables and sailcloth. More recently, Vectran® has been developed into a woven fabric, and has been used as a gut-like stringing material for tennis racquets, and in racquets themselves. The Vectran® brand name is owned by Kuraray Co., Ltd. of Kurashiki City, Japan. Vectran® filaments are available from Celanese Advanced Materials, Inc. of Charlotte, N.C.

Spectra® and Dyneema® are brand names for ultra-high-molecular-weight polyethylene (UHMWPE) fibers. UHMWPE fibers are used in armor, particularly body armor, and on occasion as vehicle armor. These materials are also used in fishing line, bow strings, sails, parachutes, climbing lines and mooring lines. The mark Spectra® is owned by Honeywell International Inc. of Morristown, N.J., while the mark Dyneema® is owned by DSM IP Assets B.V. (limited liability company) of Heerlen, The Netherlands. Spectra® and Dyneema® may be considered high modulus polyethylene (HMPE) filaments.

Of general interest, U.S. Pat. Nos. 5,901,632 and 5,931,076 disclose a braided rope construction in which filaments are turned to form twisted yarns. The twisted yarns are braided to form a braided strand, and the braided strands are themselves braided to form a braided rope. Such ropes may be used in heavy lifting or mooring applications such as marine, oceanographic, offshore oil and gas, seismic and industrial applications. The disclosed ropes are fabricated from a high modulus polyethylene (HMPE) filament, such as the Spectra® and Dyneema® materials. While such ropes do have a load-bearing function, they do not transmit electricity along their lengths and are not configured to carry an electrical device into a wellbore.

Zylon® is the brand name for a poly-phenylenebenzobisoxazole (PBO) fiber. It is a thermoset liquid crystalline polyoxazole, or synthetic polymer material. The Zylon® trademark is owned by Toyobo Co., Ltd. of Osaka, Japan. Zylon® material has been used in body armor for police officers, as rigging material for racing yachts, and in tennis racquets. Zylon® material is known to have a tensile strength that is even greater than that of Kevlar® material.

The above synthetic materials are generally available as high tenacity fiber ropes, strands, and braids. For example, Gottifredi Maffioli S.p.A. of Novara, Italy offers high tenacity halyards of a double braid construction made of various synthetic materials. These materials may include polyester fibers, Technora® fibers, Zylon® filaments, Dyneema® filaments, Vectran® fibers or Zylon® fibers The halyards may have diameters up to 22 mm.

In the United States, New England Ropes of Fall River, Mass. offers a high-performance double-braided rope (STA-SET T-900), consisting of blended Spectra® filaments and Technora® filaments within a braided polyester jacket. The ropes typically have a diameter of up to 1.5 inches (34 mm). Sampson Rope Technologies of Ferndale, Wash. offers two yacht racing ropes. The first rope is the VALIDATOR SK, a double braid construction having a blended, urethane coated core of Vectran® filaments and Dyneema® filaments within a braided polyester jacket in diameters up to 0.75 inches (17 mm). The second rope is the LIGHTNING ROPE, a twelve-strand single braid construction having a urethane coating and made from blended Dyneema® filaments and Vectran® filaments in diameters up to 0.625 inches (16 mm).

Other high-strength ropes, riggings and mooring lines are available from other sources, typically in the offshore operations and marine markets. Such sources include Phillystran, Inc. of Montgomeryville, Pa. and Oliveira Holland of Dordrecht, The Netherlands.

The above are examples of high-strength industrial ropes or mooring lines fabricated from a synthetic polymer. However, as noted above, a need remains for power cables fabricated from a high modulus, non-conductive material, or filaments thereof. Any of the synthetic materials listed above, or combinations of fibers thereof, are suitable for use as the inner sheaths 320A of power cable 300A to substantially increase tensile strength while reducing carry weight.

Returning to FIG. 2, regardless of the polymeric material 320A, the insulated conductors 310 may be aligned axially along the cable 300. The insulated conductors 310 may then be bundled within the surrounding non-conductive synthetic outer sheath 330. The outer sheath 330 is preferably a thermoplastic sheath material, such as Polyvinyl Chloride (PVC) or Thermoplastic Elastomer (TPE). PVC is preferred due to its low cost and favorable properties, including high physical strength, good moisture resistance, adequate oil resistance, good flame resistance and excellent resistance to weathering. TPE provides flame resistance, good low temperature performance, good abrasion resistance and good physical strength.

The material of the outer sheath 330 may alternatively be Polyethylene (PE). PE is usually categorized under three different densities—1) Low density (0.91-0.925 g/cm3), 2) Medium density (0.926-0.94 g/cm3), and 3) High density (0.941-0.965 g/cm3). PE sheaths have good physical strength, excellent moisture resistance, good ageing properties, but poor flame resistance. Like PVC, PE will melt at high temperatures. Alternatively, the sheath material 330 may be fabricated from Chlorinated Polyethylene (CPE). CPE is similar to PVC, but has better high temperature properties. Alternatively still, the sheath material 330 may be fabricated from nylon. Nylon provides good physical strength, reasonable abrasion resistance, very low friction when in contact with conduit materials (which aids in pulling cables), and good resistance to oils and organic solvents. However, nylon can be sensitive to strong acids and oxidizing agents.

Optionally, additional layers of polymer or other cladding material may be added to the sheath 330 for insulation, durability, gas migration prevention, or other needs. An example of a light-weight cladding material would be polypropylene or, alternatively, Zylon® fibers. Zylon® has 5.8 GPa of tensile strength which is 1.6 times that of Kevlar®.

In the arrangement of FIG. 3A, the high-strength synthetic material 320A is shown as a series of inner sheaths around each conductor wire 310. The synthetic material of the inner sheaths 320A runs the length of the cable 300A. The conductor wires 310 and associated high-strength synthetic material sheaths 320A are preferably spaced apart within the non-conductive synthetic outer sheath 330, and are supported by a filler material 340A. The filler material 340A may be a viscous polymer material that is extruded between insulated conductor wires 310 and the surrounding outer sheath material 330. The filler material 340A may be applied to link the internal conductor wires 310 to provide stability to the cable 300A.

Preferably, the filler material 340A is formed of polyvinylidene fluoride (PVDF), such as Dyneon™ 31508/003, available from Dyneon LLC of Oakdale, Minn., a 3M Company. Other polymeric materials may be used to form the inner filler material 340A, such as polyvinylchloride (PVC), polybutyl terephthalate (PBT), polyethylene (PE) and mixtures and co-polymers thereof, such as medium density polyethylene (MDPE), linear low density polyethylene (LLDPE), low density polyethylene (LDPE), and high density polyethylene (HDPE). In one aspect, the filler material 340A itself includes lyotropic polymer filaments, though this is not preferred for the embodiment of FIG. 3A.

In FIG. 3A, the high strength material is found in the inner sheaths 320A. However, in a second embodiment the high strength material is found in the filler material. In this instance, the inner sheath material may simply be a thin, polypropylene jacket or other polymeric material.

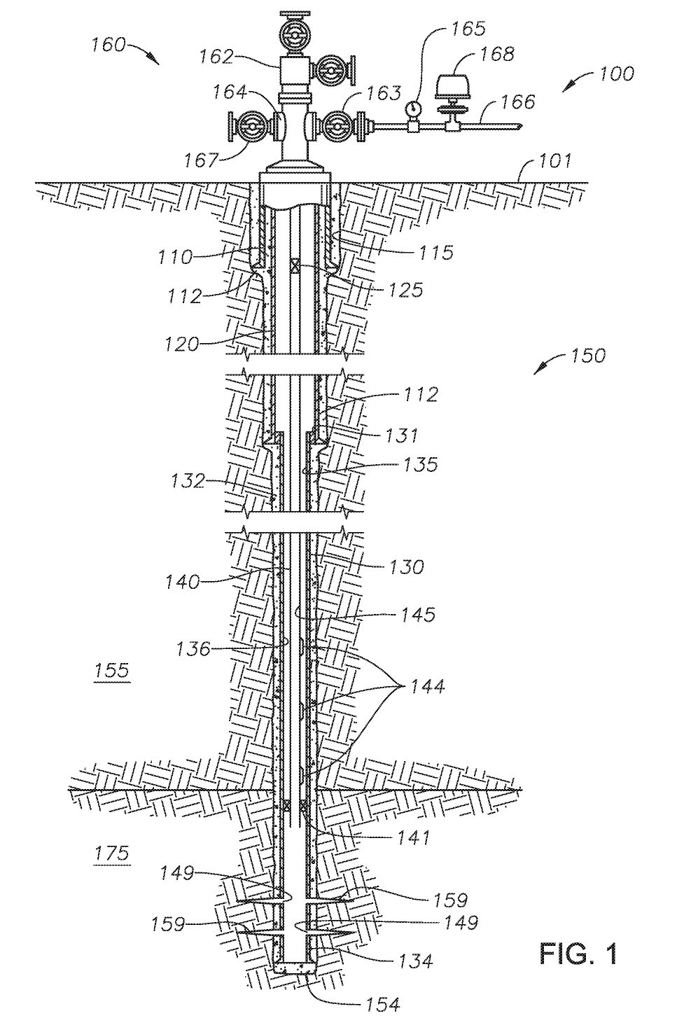

FIG. 3B-1 is an enlarged, axial cross-sectional view of the power cable 300 of FIG. 2, in the alternate embodiment. Here, a cable 300B having seven conductor wires 310 is again shown. In this arrangement, each conductor wire 310 has an associated thin, non-conductive, non-load bearing insulator serving as an inner sheath 340B.

In FIG. 3B-1, the inner sheath 340B is preferably fabricated from a polymeric material. Examples again include polypropylene (PP), polyvinylchloride (PVC), polybutyl terephthalate (PBT), polyethylene (PE) and mixtures and co-polymers thereof. The outer sheath 330 may also be fabricated from any of these materials.

In FIG. 3B-1, the high-modulus, load bearing, synthetic material is shown as filler material 320B. The filler material 320B resides between the conductor wires 310 and the surrounding outer sheath 330. The filler material 320B may be comprised of aramid fibers such as Kevlar® or Twaron®. Alternatively, the filler material 320B may be comprised of high modulus polyethylene (HMPE) filaments. In one aspect, the filler material 320B comprises liquid crystal polymer (LCP) filaments selected from the group consisting of lyotropic polymer filaments and thermotropic polymer filaments. Lyotropic polymers decompose before melting but form liquid crystals in solution under appropriate conditions. Lyotropic polymer filaments include, for example, aramid (e.g., Kevlar®) and PBO (e.g., Zylon®) fibers. Thermotropic polymers exhibit liquid crystal formation in melt form. Thermotropic filaments are commercially available under, for example, the trade name Vectran®. The filaments may be 0.5-20 denier per filament (dpf).

FIG. 3B-2 is an enlarged, perspective, cut-away view of the power cable of FIG. 3B-1, in a modified embodiment. Here, the seven conductor wires 310′ are shown, but in stranded form. Stranded wires have more flexibility than individual conductor wires. The conductor wires 310′ are again insulated using a thin inner sheath 340B, and have a surrounding high-strength, synthetic filler material 320B. In this arrangement, the conductor wires 310′ are arranged immediately adjacent to one another within the center of the cable 300B.

When the synthetic material 320B is carrying the tensile load, it is optional for the metal conductors 310′ to have some helical winding, twists or braids inside of the synthetic filler material 320B. As an option, the synthetic filler material 320B may comprise braided fibers. Braided materials have a higher coefficient of elasticity or “stretch” than a singular body of material.

Optionally, fiber optic cables, hydraulic lines, chemical injection lines, or other service lines may be added within the non-conductive and corrosion-resistant sheath 330. FIG. 3C is an enlarged, axial cross-sectional view of the power cable 300 of FIG. 2, in an alternate embodiment. Here, a power cable 300C having five conductor wires 310 inside of the outer sheath 330 is shown. Each conductor wire 310 resides within an insulating inner sheath 320C fabricated from a high strength synthetic material.

A filler material 340C is extruded into the region formed between the conductor wires 310 and the outer sheath 330. The filler material 340C may be a polymeric material or a nylon material having little to no load bearing capacity. Alternatively, the filler material 340C may include HMPE filaments for strength.

In addition, the cable 300C includes a fiber optic data cable 360 and two service lines 370, 380. Service line 370 may carry, for example, a treating chemical such as a corrosion inhibitor, a scale inhibitor, or glycol. Service line 380 may carry, for example, a hydraulic fluid used for actuating a valve or sleeve or other tool (not shown).

FIG. 4 is a longitudinal cross-sectional view of the cable 300 of FIG. 2. Here, the cable 300 is shown mechanically connected to a downhole electrical device 400. The downhole electrical device 400 is preferably a submersible pump. The submersible pump may have either a linear drive motor or a rotary drive motor. Alternatively, the submersible pump may be one or more micro-PD pumps placed within a wellbore in series.

In FIG. 4, a lower portion of a power cable 200′ is shown. Visible along the cross-sectional cut are seven conductor wires 310 and one fiber optic cable 360. Also visible is a light-weight, high-strength synthetic filler material 320B. These components reside within a polypropylene outer sheath 330.

The power cable 200′ gravitationally supports the downhole electronic device 400. The device 400 is preferably a submersible pump dimensioned to reside within a production tubing (not shown). The device 400 has a lower end 412 and an upper end 414. A lower portion of the power cable 200′ is shown in cut-away view, revealing various conductor wires 310 extending out of the bottom of the cable 200′ and into a housing 410 for the electronic device 400.

The electronic device 400 carries a cable head 420 at its upper end 414. The cable head 420 transfers conductive wires 310 and all service wires into the housing 410. One or more mechanical connectors 415 is used to secure the cable head 420 to the housing 410. Beneficially, the cable head 420 is mechanically connected to both the outer sheath 330 and to the high-strength filler material 320B.

The cable head 420 of FIG. 4 is shown somewhat schematically. Those of ordinary skill in the art will understand that the cable head 420 may be adapted to any of cables 300A, 300B and 300C, wherein high-strength, low weight, synthetic material 320A, 320B, 320C supports the cable 200′ and the connected pump 400.

As can be seen, a cable is provided having a high strength-to-weight ratio, along with corrosion resistance. The cable is fitted to supply power within the harsh environs of a wellbore for an extended duration.

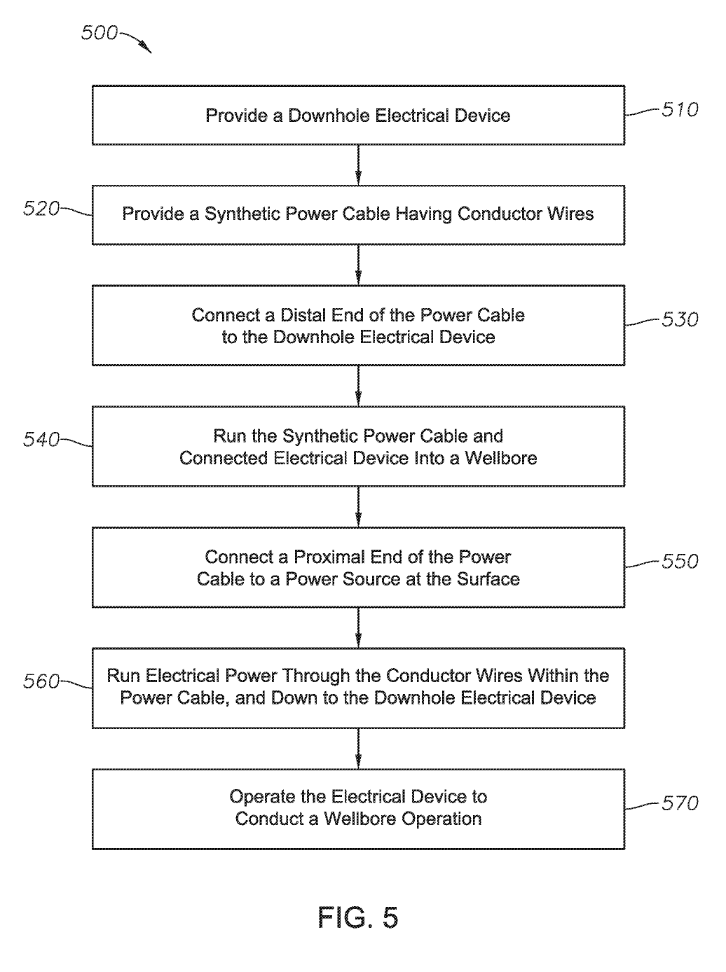

Based on the above descriptions for a power cable 300 and a spool 200 for the cable 300, a method for pumping fluids from a wellbore is provided herein. The method is presented in FIG. 5. FIG. 5 presents a flowchart for a method 500 of pumping fluids from a wellbore, in one embodiment. Preferably, the wellbore is an extended length wellbore that traverses multiple zones across more than 7,500 feet of vertical or deviated hole. The method 500 involves running a synthetic power cable and connected submersible pump into a wellbore, and then actuating the pump to move hydrocarbon fluids from a subsurface formation to the surface.

In one aspect, the method 500 first comprises providing a downhole electrical device. In the current method 500, the device is preferably a submersible pump in a wellbore. This is shown at Box 510. The electrical submersible pump may have a rotary motor or a linear drive motor. In one aspect, the electrical pump is one or more micro-positive displacement pumps. In another embodiment, the electrical pump is a solid state downhole pump.

The method 500 also includes providing a synthetic power cable. This is indicated at Box 520. The synthetic power cable may be any of the light-weight, high-tensile-strength cables described above, including those shown at 300A, 300B and 300C. The power cable has one or more conductor wires which together are capable of transmitting at least 1,500 Watts of electrical power and, more preferably, greater than 2,500 Watts of power.

The method 500 further comprises connecting a distal end of the electrical cable to the electrical submersible pump. This is provided at Box 530.

The method 500 additionally includes running the synthetic power cable and connected submersible pump into a wellbore. This is seen at Box 540. Preferably, the method of Box 540 is done before the pump (or other electrical device) is run into the wellbore. In one aspect, the electrical cable is connected to an outer diameter of a production tubing as the production tubing is run into the wellbore, joint by joint. In this instance, the electrical submersible pump is connected to an inner diameter of the production tubing proximate a distal end of the production tubing. Running the electrical cable and connected submersible pump into the wellbore comprises unspooling the electrical cable as the production tubing is run into the wellbore.

In another aspect, the step 540 of running the electrical cable and connected submersible pump into the wellbore comprises unspooling the electrical cable and connected submersible pump into a string of production tubing within the wellbore.

The method 500 additionally includes connecting a proximal end of the power cable to a power source at the surface. This is seen at Box 550. The method 500 then includes running electrical power through the conductor wires within the power cable, and down to the electrical submersible pump. This is indicated at Box 560.

The method 500 finally includes operating the electrical submersible pump to pump fluids up the production tubing and to the surface. This is provided at Box 570. The fluids are preferably hydrocarbon liquids.

It is observed that the electrical submersible pump may be any downhole electrical device. The step of Box 570 may be phrased as operating the downhole electrical device to perform a wellbore operation.

The power cable of the present invention may be manufactured through a series of novel steps. The first step is to build or produce an inventory of cable constituents. The constituents preferably include bundles of stranded conductors 310 interior to inner sheaths (320A, 340B, or 320C), thus producing insulated stranded wires. The insulated bundles of stranded wires 310 within 320A or within 320B or within 320C are preferably fabricated by an extrusion process for typical stranded wires or, more preferably, for increased strength to weight characteristics by copper plating on nickel processed aramid or similar fibers. Additional sheathed service lines 370 and 380 and sheathed fiber optics lines 360 are manufactured and inventories built.

The manufactured cable constituents including the selected combinations of insulated wires 310, sheathed service lines 370 and 380, and sheathed fiber optics lines 360 are collected on separate reels and provided to a cable assembly machine. A pre-manufactured source of filler material 320B is provided to the cable assembly machine. The cable assembly machine may produce the assembled cable by pulling the constituents of the cable through the machine and guided out through an extrusion die as the outer sheath 330 is formed. Such an extrusion process may be referred to as pultrusion. It is understood that the constituents of the cable may be twisted by a cable assembly machine head during the outer sheathing or molding process of cable assembly.

As the assembled power cable 300 exits the extrusion machine, it is wound upon a spool 200 with the proximal end 302 exposed for termination. The power cable 300 is wound on the spool 200 in even layers until the spool 200 is fully loaded. The power cable 300 is then sheared or cut loose from the cable assembly machine with the distal end 304 exposed for termination. A next reel or spool is prepositioned such that the cable assembly machine can begin feeding additional assembled power cable to the empty reel without significant delay to the assembly and extrusion process.

While it will be apparent that the inventions herein described are well calculated to achieve the benefits and advantages set forth above, it will be appreciated that the inventions are susceptible to modification, variation and change without departing from the spirit thereof. Improved means of delivering power to an electrical device, such as an electric submersible pump, within a wellbore are provided so as to reduce cable weight without compromising tensile strength and enhance corrosion resistance as compared to typical carbon-steel wirelines.

What is claimed is:

1. A power cable bundle, comprising:
a spool having an axle; and
a power cable wound about the axle, the power cable comprising:
a plurality of conductor wires capable of carrying together enough current to generate at least 1,500 Watts of electrical power;
a non-conductive outer sheath providing a uniform outer diameter for the cable around the plurality of conductor wires; and
a non-conductive, synthetic material around the plurality of conductor wires substantially along its length, the material (i) having a tensile strength of at least 2,000 MPa (29,075 psi) during load bearing, and (ii) having a weight that is less than 0.1 lb./ft. in air.

2. The power cable bundle of claim 1, wherein:
the power cable is at least 2,000 feet in length;
the synthetic material has a tensile strength of at least 3,000 MPa (43,511 psi) during load bearing; and
the synthetic material is fabricated from a material that will not corrode when exposed to a hydrocarbon fluid comprising hydrogen sulfide or carbon dioxide and a temperature below 300° F.

3. The power cable bundle of claim 2, wherein the synthetic material has a relative density of at least 1.00.

4. The power cable bundle of claim 2, wherein the outer sheath is fabricated from a polymeric material.

5. The power cable bundle of claim 2, wherein:
the power cable is at least 2,000 feet in length;
each conductor wire is insulated by an inner sheath having a thickness no greater than 1,500 μm, the inner sheath also being fabricated from a polymeric material;
the synthetic material defines a filler material that resides between the conductor wires and the surrounding outer sheath; and
the synthetic material is fabricated at least partially from high modulus polyethylene filaments, lyotropic polymer filaments, thermotropic polymer filaments, or combinations thereof.

6. The power cable bundle of claim 5, wherein the filler material is fabricated from Kevlar®, Twaron®, Zylon®, Dyneema®, Vectran®, Spectra®, Technora®, or combinations of fibers thereof.

7. The power cable bundle of claim 6, wherein the polymeric material comprises polyvinylidene fluoride (PVDF), polypropylene (PP), polyvinylchloride (PVC), polybutyl terephthalate (PBT), polyethylene (PE) or mixtures and co-polymers thereof.

8. The power cable bundle of claim 7, further comprising (i) at least one fluid-carrying service line within the outer sheath, (ii) at least one fiber optic data cable within the outer sheath, or (iii) both.

9. The power cable bundle of claim 2, wherein:
the power cable is at least 2,000 feet in length;
the synthetic material defines a jacket around each conductor wire to form a plurality of inner sheaths, with each of the inner sheaths having a thickness no greater than 1,500 μm;
each of the inner sheaths is fabricated at least partially from high modulus polyethylene filaments, lyotropic polymer filaments, thermotropic polymer filaments, or combinations thereof; and
the cable further comprises a filler material that resides between the conductor wires and the surrounding outer sheath.

10. The power cable bundle of claim 9, wherein each of the inner sheaths is fabricated from Kevlar®, Twaron®, Zylon®, Dyneema®, Vectran®, Spectra®, Technora®, or combinations of fibers thereof.

11. The power cable bundle of claim 10, wherein the filler material is a polymeric material that comprises polyvinylidene fluoride (PVDF), polypropylene (PP), polyvinylchloride (PVC), polybutyl terephthalate (PBT), polyethylene (PE) or mixtures and co-polymers thereof.

12. The power cable bundle of claim 10, wherein the filler material is also fabricated from Kevlar®, Twaron®, Zylon®, Dyneema®, Vectran®, Spectra®, Technora®, or combinations of fibers thereof.

13. The power cable bundle of claim 10, further comprising (i) at least one fluid-carrying service line within the outer sheath, (ii) at least one fiber optic data cable within the outer sheath, or (iii) both.

14. The power cable bundle of claim 1, wherein:
each of the conductor wires resides within an inner sheath; and
each of the conductor wires resides (i) co-axially within the outer sheath, or (ii) in parallel relation within the outer sheath.

15. A power cable, comprising:
a plurality of conductor wires capable of carrying sufficient current together to generate at least 1,500 Watts of electrical power;
a non-conductive, synthetic material around the plurality of conductor wires substantially along its length, the material (i) having a tensile strength of at least 2,000 MPa. (29,075 psi), and (ii) having a weight that is less than 0.1 lb./ft. in air; and
an outer sheath fabricated from a non-conductive polymeric material, the sheath forming a uniform outer diameter for the power cable; and
wherein the power cable is at least 2,000 feet in length.

16. The power cable of claim 15, wherein:
the synthetic material is fabricated from a material that will not corrode when exposed to a hydrocarbon fluid comprising hydrogen sulfide or carbon dioxide and a temperature below 300° F.; and
the synthetic material has a relative density of at least 1.00.

17. The power cable of claim 16, wherein the power cable has a tensile strength of at least 3,000 MPa (43,511 psi).

18. The power cable of claim 15, wherein:
each conductor wire is insulated by an inner sheath having a thickness no greater than 1,500 μm, the inner sheath also being fabricated from a polymeric material;
the synthetic material defines a filler material that resides between the conductor wires and the surrounding outer sheath; and
the synthetic material is fabricated at least partially from high modulus polyethylene filaments, lyotropic polymer filaments, thermotropic polymer filaments, or combinations thereof.

19. The power cable of claim 18, wherein the filler material is fabricated from Kevlar®, Twaron®, Zylon®, Dyneema®, Vectran®, Spectra®, Technora®, or combinations of fibers thereof.

20. The power cable of claim 19, wherein the polymeric material comprises polyvinylidene fluoride (PVDF), polypropylene (PP), polyvinylchloride (PVC), polybutyl terephthalate (PBT), polyethylene (PE) or mixtures and co-polymers thereof.

21. The power cable of claim 18, further comprising (i) at least one fluid-carrying service line within the outer sheath, (ii) at least one fiber optic data cable within the outer sheath, or (iii) both.

22. The power cable of claim 15, wherein:
the synthetic material defines a jacket around each conductor wire to form a plurality of inner sheaths, each inner sheath having a thickness no greater than 1,500 μm;
each of the inner sheaths is fabricated at least partially from high modulus polyethylene filaments, lyotropic polymer filaments, thermotropic polymer filaments, or combinations thereof; and
the cable further comprises a filler material that resides between the conductor wires and the surrounding outer sheath.

23. The power cable of claim 22, wherein the inner sheath is fabricated from Kevlar®, Twaron®, Zylon®, Dyneema®, Vectran®, Spectra®, Technora®, or combinations of fibers thereof.

24. The power cable of claim 23, wherein the filler material is a polymeric material that comprises polyvinylidene fluoride (PVDF), polypropylene (PP), polyvinylchloride (PVC), polybutyl terephthalate (PBT), polyethylene (PE) and mixtures and co-polymers thereof.

25. The power cable of claim 24, wherein the filler material is further fabricated from Kevlar®, Twaron®, Zylon®, Dyneema®, Vectran®, Spectra®, Technora®, or combinations of fibers thereof.

26. The power cable bundle of claim 15, further comprising (i) at least one fluid-carrying service line within the outer sheath, (ii) at least one fiber optic data cable within the outer sheath, or (iii) both.

27. The power cable of claim 15, wherein each of the conductor wires resides (i) co-axially within the outer sheath, or (ii) in parallel relation within the outer sheath.

28. A method of pumping fluids from a wellbore, comprising:
providing a downhole electrical device;
connecting a distal end of an electrical cable to the downhole electrical device, the electrical cable comprising:
a plurality of conductor wires capable of carrying sufficient current together to generate at least 1,500 Watts of electrical power;
a non-conductive, synthetic material around the plurality of conductor wires substantially along its length, the material having (i) a tensile strength of at least 2,000 MPa. (29,075 psi), and (ii) a weight that is less than 0.1 lb./ft. in air; and
an outer sheath fabricated from a non-conductive material, the sheath forming a uniform outer diameter for the power cable; and
wherein the power cable is at least 2,000 feet in length,
connecting a proximal end of the power cable to a power source at the surface;
running the electrical cable and connected downhole electrical device into the wellbore;
running electrical power through the conductor wires within the power cable, and down to the electrical device; and
operating the electrical device to perform a wellbore operation.

29. The method of claim 28, wherein:
the downhole electrical device is an electrical submersible pump;
connecting the electrical cable to the electrical device comprises connecting the electrical cable to the electrical submersible pump; and
operating the electrical device comprises operating the submersible pump to pump fluids up a production tubing and to the surface.

30. The method of claim 29, wherein the electrical submersible pump comprises a rotary motor or a linear drive motor.

31. The method of claim 29, wherein the electrical submersible pump is a micro-positive displacement pump or a solid state pump.

32. The method of claim 29, wherein connecting the electrical cable to the electrical submersible pump comprises placing the electrical cable in electrical communication with a motor of the electrical submersible pump before the pump is run into the wellbore.

33. The method of claim 32, wherein:
the electrical cable is connected to an outer diameter of the production tubing as the production tubing is run into the wellbore, joint by joint;
the electrical submersible pump is connected to an inner diameter of the production tubing at a distal end of the production tubing; and
running the electrical cable and connected submersible pump into the wellbore comprises unspooling the electrical cable as the production tubing is run into the wellbore.

34. The method of claim 32, wherein running the electrical cable and connected submersible pump into the wellbore comprises unspooling the electrical cable and connected submersible pump into the string of production tubing within the wellbore.

35. The method of claim 29, wherein the pump is run into the wellbore to a depth that is greater than 5,000 feet.

36. The method of claim 29, wherein:
the outer sheath comprises a polymeric material;
each conductor wire is insulated by an inner sheath having a thickness no greater than 1,500 μm, the inner sheath also being fabricated from a polymeric material;
the synthetic material defines a filler material that resides between the conductor wires and the surrounding outer sheath; and
the synthetic material is fabricated at least partially from high modulus polyethylene filaments, lyotropic polymer filaments, thermotropic polymer filaments, or combinations thereof.

37. The method of claim 36, wherein the filler material is fabricated from Kevlar®, Twaron®, Zylon® Dyneema®, Vectran®, Spectra®, Technora®, or combinations of fibers thereof.

38. The power cable of claim 37, wherein the polymeric material comprises polyvinylidene fluoride (PVDF), polypropylene (PP), polyvinylchloride (PVC), polybutyl terephthalate (PBT), polyethylene (PE) or mixtures and co-polymers thereof.

39. The method of claim 37, further comprising (i) at least one fluid-carrying service line within the outer sheath, (ii) at least one fiber optic data cable within the outer sheath, or (iii) both.

40. The method of claim 29, wherein:
the outer sheath comprises a polymeric material;
the synthetic material defines a jacket around each conductor wire to form a plurality of inner sheaths, with each inner sheath having a thickness no greater than 1,500 μm;
each of the inner sheaths is fabricated at least partially from lyotropic polymer filaments, thermotropic polymer filaments, or combinations thereof; and
the cable further comprises a filler material that resides between the conductor wires and the surrounding inner sheath.

41. The method of claim 40, wherein each of the inner sheaths is fabricated from Kevlar®, Twaron®, Zylon®, Dyneema®, Vectran®, Spectra®, Technora®, or combinations of fibers thereof.

42. The method of claim 41, wherein the filler material is a polymeric material that comprises polyvinylidene fluoride (PVDF), polypropylene (PP), polyvinylchloride (PVC), polybutyl terephthalate (PBT), polyethylene (PE) or mixtures and co-polymers thereof.

43. The method of claim 42, wherein the filler material is further fabricated from Kevlar®, Twaron®, Zylon® Dyneema®, Vectran®, Spectra®, Technora®, or combinations of fibers thereof.

44. The method bundle of claim 41, wherein the power cable further comprises (i) at least one fluid-carrying service line within the outer sheath, (ii) at least one fiber optic data cable within the outer sheath, or (iii) both.
